(19) United States
(12) Patent Application Publication
(10) Pub. No.: US 2016/0364115 A1
(43) Pub. Date: Dec. 15, 2016

(54) METHOD, SYSTEM, AND MEDIA FOR COLLABORATIVE LEARNING

(71) Applicant: Scapeflow, Inc., New York, NY (US)

(72) Inventor: Mookwang R. Joung, New York, NY (US)

(73) Assignee: Scapeflow, Inc., New York, NY (US)

(21) Appl. No.: 15/180,520

(22) Filed: Jun. 13, 2016

Related U.S. Application Data
(60) Provisional application No. 62/174,876, filed on Jun. 12, 2015.

(51) Int. Cl. G06F 3/0481; G06F 3/0484; G09B 5/02; G06T 11/20; H04L 29/08; G06F 3/0482; G06K 9/46

(52) U.S. Cl. CPC G06F 3/04817; G06F 3/0482; G06F 3/04842; G06K 9/4604; G06T 11/206; H04L 67/10; G09B 5/02; G06T 2200/24

(57) ABSTRACT

A computer-implemented method, system, and computer program for collaborative learning. The method, system, and computer program includes a computer including a display, a graphics processing unit, and a microprocessor, the computer programmed to receive at least one item and transmit the at least one item, a server comprising a central processing unit and a memory, the server configured to receive the at least one item from the computer, the memory having the at least one item stored therein, and the central processing unit programmed to: determine a group of the at least one item that is connected by a plurality of weighted edges; determine at least one set of characteristics based on the at least one item; determine at least one measured relationship between each characteristic in the at least one set of characteristics; and generate a visual landscape based on the at least one measured relationship.

### CROSS-REFERENCE TO RELATED APPLICATION

The present application claims priority under 35 U.S.C. §119(e) to U.S. Provisional Patent Application No. 62/174,876 filed on Jun. 12, 2015, which is hereby incorporated by reference.

### FIELD OF THE DISCLOSURE

The present disclosure relates to a method, a system, and a computer program for collaborative learning, and more particularly to a method, a system, and a media for computer-based learning over a computer network through a visual display interface in the form of a knowledge landscape that is constructed collaboratively.

### BACKGROUND OF THE DISCLOSURE

The World Wide Web contains abundant resources that cover a substantial fraction of human knowledge, and can be easily accessed via, e.g., internet. The challenge exists in quickly locating high-quality contents from a vast sea of information that meet an individual user's specific objectives and preferences. Currently existing search engines are technologically inefficient when it comes to learning as the user often has to visit multiple websites before finding a content that the user is searching for. This is true despite the fact that contents for education (and to some extent, for corporate training) are some of the most slowly changing, stable body of knowledge, and are therefore used repeatedly over time.

An unfulfilled need exists for a means to enable collaborative construction and navigation of a knowledge landscape and computer-based learning via e.g., a graphical user interface. The present disclosure provides a method, a system, and a computer program for learning over a computer network through a visual display interface, such as, for example, in a form of a knowledge landscape that is constructed collaboratively.

### SUMMARY OF THE DISCLOSURE

The present disclosure provides a method, a system, and a computer program for learning over a computer network through a visual display interface, such as, for example, in a form of a knowledge landscape that is constructed collaboratively, as disclosed herein.

In an aspect of the present disclosure, a computer-implemented system for collaborative learning is disclosed. The computer-implemented system includes a display, a graphics processing unit, and a microprocessor, the computer programmed to receive at least one item and transmit the at least one item, a server including a central processing unit and a memory, the server configured to receive the at least one item from the computer, the memory having the at least one item stored therein, and the central processing unit programmed to: determine a group of the at least one item that is connected by a plurality of weighted edges; determine at least one set of characteristics based on the at least one item and the group of the at least one item; determine at least one measured relationship between each characteristic in the at least one set of characteristics; and generate a visual landscape or a plurality of visual landscapes, that is determined, organized, visualized, and updated based on the at least one measured relationship, wherein the graphics processing unit is configured to display the visual landscape on the display, and wherein the computer is connected to the server via a communication link.

In an embodiment of the present disclosure, the server may include a graphics processing unit that is configured to execute at least part of the central processing unit's programming.

In another embodiment of the present disclosure, the at least one item may include at least one of concept, topic, content, document, question, learning goal, objective, and/or performance expectation.

In yet another embodiment of the present disclosure, the weighted edges may comprise any one or more of linear sequences, non-linear sequences, loops, trees, graphs, and/or combination thereof.

The central processing unit may be further programmed to create a mathematical model to calculate the at least one measured relationship between characteristics.

The characteristics may include at least one of user-item interaction data, user profiles, item profiles, item-item relations, and lesson profiles.

The group of at least one item connected by a plurality of weighed edges may include at least one lesson plan that is arranged in a sequence or a directed graph based on a degree of temporal or logical precedence.

The at least one item or the at least one lesson plan may be organized into multiple tiers based on their measured difficulty level. The at least one item or the at least one lesson plan may be inputted by a user. The input from the user may include at least one of graphical, textual, or numerical form. The at least one lesson plan may be automatically formed based on analyses of the visual landscape and the group of the at least one item.

In an embodiment of the present disclosure, a visual attribute of the at least one item or the at least one lesson plan in the visual display may be determined and organized based on at least one conceptual relationship between any one or more of the at least one item, the group of the at least one item, the at least one lesson plan, and a user feedback.

In another embodiment of the present disclosure, a visual attribute of the at least one item or the at least one lesson plan in the visual display may be determined and organized based on the at least one set of characteristics of any one or more of the at least one item, the group of the at least one item, the at least one lesson plan, and a user feedback.

The visual attribute may include at least one of geometric or geographical property. The visual attribute may further include at least one of line, polygon, coordinate, path, area, volume, elevation, depth, environment, surface texture, shape, icon, size, width, distance, color, and/or brightness.

In an embodiment of the present disclosure, the visual landscape may include at least one of landscape, seascape, cityscape, underground, and/or outer space. The visual landscape may be displayed to a user in a static or dynamic manner. The visual landscape may be displayed in a two-dimensional or three-dimensional space.

In an embodiment of the present disclosure, the microprocessor may be configured to display the visual landscape on the display.

In yet another embodiment of the present disclosure, the system may include a computer input apparatus that is configured to permit a user to navigate and zoom in and out of the visual landscape.

In an aspect of the present disclosure, non-transitory computer readable storage medium tangibly embodying a computer readable program code having computer readable instructions which, when implemented, cause a computer to carry out a plurality of method steps including: receiving at least one item from a user on the computer, and transmitting the at least one item to a central processing unit on a server, wherein the central processing unit is configured to execute the steps including: determining a group of the at least one item that is connected by a plurality of weighted edges; determining at least one set of characteristics based on the at least one item; determining at least one measured relationship between each characteristic in the at least one set of characteristics; and generating a visual landscape that is continuously determined, organized, visualized, and updated based on the at least one measured relationship.

In an embodiment of the present disclosure, the computer may include a graphics processing unit that is configured to execute a least part of the central processing unit's programming.

In yet another aspect of the present disclosure, a computer-implemented system for collaborative learning is disclosed. The computer-implemented system includes a display, a graphics processing unit, and a microprocessor, the computer programmed to receive at least one item and transmit the at least one item, a server including a central processing unit and a memory, the server configured to receive the at least one item from the computer, the memory having the at least one item stored therein, and the central processing unit programmed to: determine a group of the at least one item that is connected by a plurality of weighted edges; determine at least one set of characteristics based on the at least one item and the group of the at least one item; determine at least one measured relationship between each characteristic in the at least one set of characteristics; and generate a visual landscape or a plurality of visual landscapes, that is determined, organized, visualized, and updated based on the at least one measured relationship, wherein the microprocessor is configured to display the visual landscape on the display, and wherein the computer is connected to the server via a communication link.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system constructed according to the principles of the disclosure.

FIG. 2 shows an example of a block diagram of components of a system for collaborative knowledge landscape construction and computer-based learning that is constructed according to the principles of the disclosure.

FIG. 3 shows an example of a block diagram of a process for a learning session that is constructed according to the principles of the disclosure.

FIG. 4 shows an example of a diagram of a process for navigating knowledge landscape, browsing, and selecting a study item that is constructed in accordance with the principles of the disclosure.

FIG. 5 shows a diagram of a process for learning process, in which a learner interacts with study items or lessons that is constructed in accordance with the principles of the disclosure.

FIG. 6 shows an example of a diagram of a process for creating a new lesson plan that is constructed according to the principles of the disclosure.

FIG. 7 shows an example of a knowledge landscape for navigating a two-dimensional knowledge landscape that is constructed in accordance with the present disclosure.

FIG. 8 shows an example of a knowledge landscape for navigating a two-dimensional knowledge landscape that is zoomed in on a particular lesson that is constructed in accordance with the present disclosure.

FIG. 9 shows an example of a knowledge landscape for exploring a three-dimensional knowledge landscape that is constructed in accordance with the present disclosure.

FIG. 10 shows another example of a knowledge landscape for exploring a three-dimensional knowledge landscape, in a view that zooms in on a particular study item, that is constructed in accordance with the present disclosure.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as any person skilled in the art would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a graphics processing unit, a general purpose computer, a cloud, a super computer, a personal computer, a laptop computer, a palmtop computer, a mobile device, a tablet computer, a set-top box, a game console, a notebook computer, a desktop computer, a workstation computer, a server, or the like, or an array of processors, microprocessors, central processing units, graphics processing units, general purpose computers, super computers, personal computers, laptop computers, palmtop computers, mobile devices, tablet computers, set-top boxes, game consoles, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “database,” as used in this disclosure, means any combination of software and/or hardware, including at least one application and/or at least one computer. The database may include a structured collection of records, data structures in memory, or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, the cloud network, or the like, or any combination of the foregoing, any of which may be configured to communicate data via a wireless and/or a wired communication medium. These networks may run a variety of protocols not limited to TCP/IP, IRC or HTTP.

A “learner” or “user,” as used in this disclosure means a person, such as, for example, but not limited to, a student, a teacher, an instructor, an employee, a manager, a publisher, an advertiser, and the like.

A “monitor,” as used in this disclosure means a person (such as, for example, a system supervisor, a manager, a teacher, an instructor, a publisher, an advertiser, and the like), an expert system (such as, for example, a computer with artificial intelligence, a neural network, fuzzy logic, and the like), a computer, and the like.

A “study item” or “item,” as used in this disclosure means material for education and learning, usually one of contents, concepts, topics, documents, assessment questions, learning goals, objectives, performance expectations, or the like.

A “content,” as used in this disclosure means material for education and learning including a document, webpage, various types of media (text, image, audio, video, animation, infographics, and the like), or their combinations.

A “lesson,” “lesson plan,” “lesson path,” or “trail,” as used in this disclosure means a particular sequence or a directed graph connecting a plurality of study items, which may be, for example, visualized as a path or a trajectory.

A “user interaction data” or “user-item interaction data,” as used in this disclosure means descriptive information about an analyzed learning session such as, for example, start and end times, learning goal and/or lesson selected by user, navigation history, items viewed, attempted or studied, time spent on each item, assessment questions presented, user's responses to the questions, concepts mastered, lessons completed, click log, and the like.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable storage medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The present invention relates to a method, a system, and a media for collaborative computer-based learning over a computer network that makes use of a graphical user interface in a form of interactive knowledge (or visual) landscape of two or three spatial dimensions.

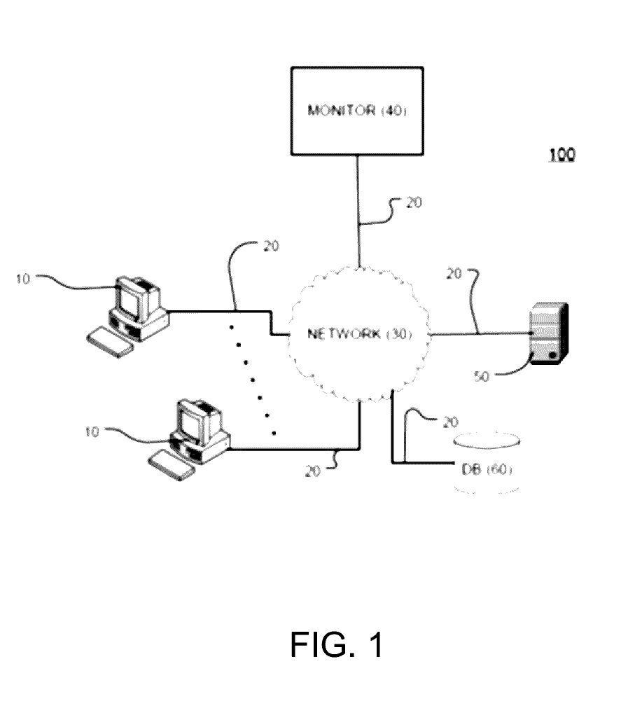

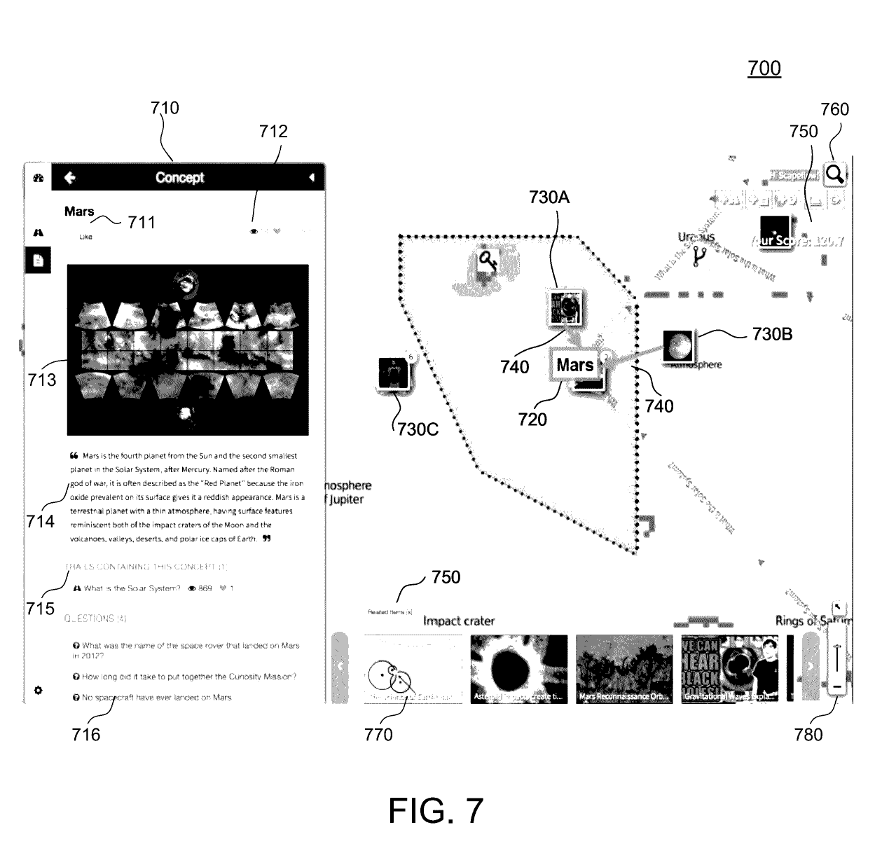

FIG. 1 shows an example of a system 100 constructed according to the principles of the disclosure that provides collaborative knowledge (or visual) landscape (as shown in, e.g., FIGS. 7-10). The system 100 includes at least one user computer 10, a network 30, a monitor (e.g., a system manager) computer 40, a server (or computer) 50, and a database 60, all of which may be coupled to each other via communication links 20. For instance, the server 50 and database 60 may be connected to each other and/or the network 30 via one or more communication links 20. The user computer 10 and the monitor computer 40 may be coupled to the network 30 via communication links 20. The user computer 10 may be used by, for example, teachers, students, employees, or the like.

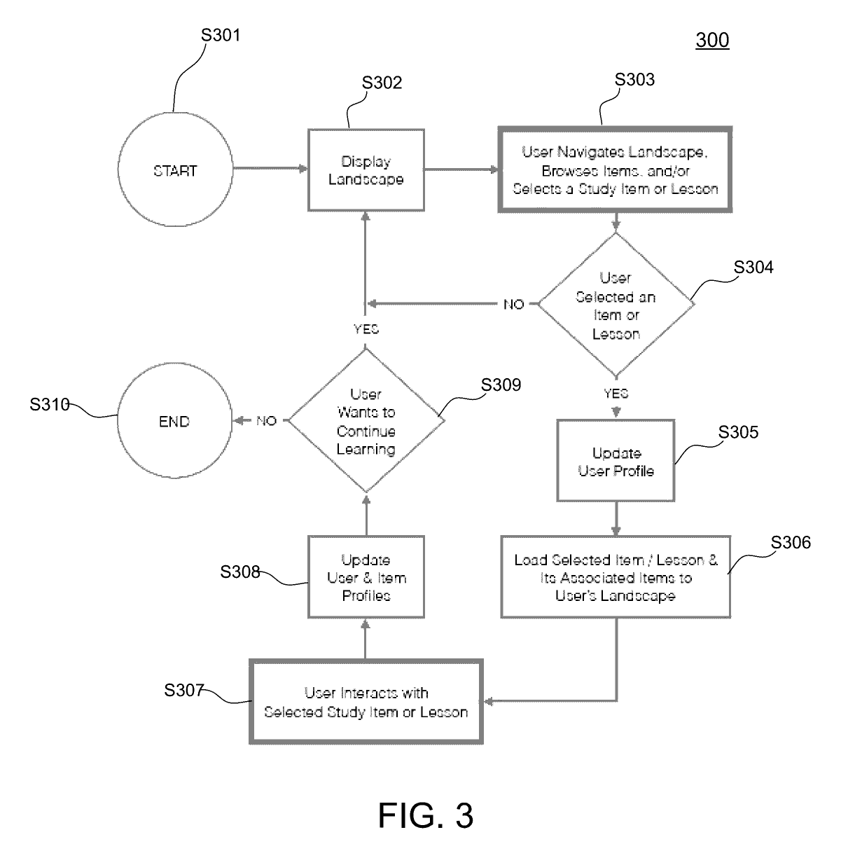

The computers 10, 40, server 50, and database 60 may each include a computer-readable medium comprising a computer program that may be executed to carry out the processes disclosed herein. The computer-readable medium may include a code section or code segment for performing each step disclosed in, e.g., FIGS. 3-6.

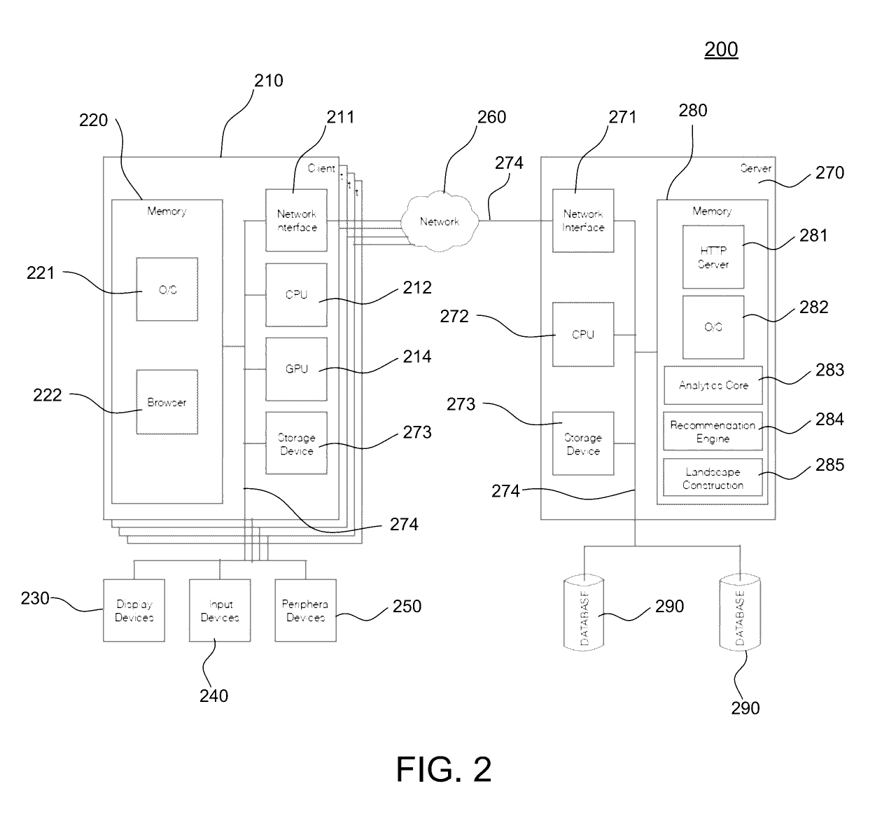

FIG. 2 shows an example of a block diagram of components of a system 200 for collaborative knowledge landscape construction and computer-based learning that is constructed according to the principles of the disclosure. The system 200 may include at least one client (or user) computer 210, at least one server 270, and at least one network 260, all of which may be coupled to each other via communication links 274. The at least one client computer 210 may include a network interface 211, a central processing unit (CPU) 212, a graphics processing unit (GPU) 214, a storage device 273, and a client memory 220. The client memory 220 may include an operating system (O/S) 221 and a browser 222. The at least one client computer 210 may further be connected to at least one display device 230, at least one input device 240, and at least one peripheral device 250 via the communication links 274.

The server 270 may include a network interface 271, a CPU 272, a storage device 273, and a server memory 280. Each of the network interface 271, the CPU 272, and the storage device 273 may be connected to the server memory 280 via the communication links 274. The server memory 280 may include a HTTP server 281, an operating system (O/S) 282, an analytics core 283, a recommendation engine 284, and a landscape construction engine 285. The server 270 may be connected to at least one database 290 via the communication links 274. In an embodiment of the present disclosure, the landscape construction engine 285 may include a landscape data (e.g., map tiles). The landscape construction engine 285 and the landscape data may be included in separate, dedicated server and database (not shown).

The landscape construction engine 285 may operate to produce and update a knowledge landscape at a prescribed time interval (e.g., hourly, weekly, monthly, or the like) or as needed. The landscape construction engine 285 may read from the at least one database 290, a user-item interaction data, visual coordinates of study item(s), and previous map tiles and landscape mesh data.

The at least one database 290 may further include a text corpus that corresponds to each item, lesson plan, lesson path, region, concept, or the like. The text corpus of each region (e.g., concept) of the knowledge landscape may be updated (e.g., to take into account newly added study items) and stored in the memory 280 or the storage device 273. The coordinates of related study items may be recomputed based on new text corpora, ontological relationships, conceptual similarity between the text corpora, and/or user-item interaction statistics.

The landscape construction engine 285 may redraw or amend the knowledge landscape to account for the recomputed adjustment. The resulting updated data, which may include map tiles, may then be stored back in database 290. For example, if there is a lesson connecting two study items located far away on the landscape as its immediately adjacent steps and if the lesson has gained a large number of views and votes and/or its high efficacy has been supported by statistical analysis of user-item interaction data, the distance between the two items may be reduced by a calculated factor on the updated landscape. This change may, in turn, affect the coordinates of each of their neighboring items, and so all of the coordinate adjustments may be performed in a self-consistent manner.

The landscape construction 285 is an example of a process used in the present disclosure to transform unstructured contents on the web into structured data so that they may be efficiently utilized for convenient, interactive learning experience. The landscape construction engine 285 may produce a knowledge landscape with two or three spatial dimensions (as shown in, e.g., FIGS. 7-10). The knowledge landscape data thus generated may be communicated through the network 260 to the at least one client computer 210, where it may be displayed via the client's CPU 212 and GPU 213 on display devices 230 as a two-dimensional tiled map, similar to many web maps that may be panned or zoomed, or as a three-dimensional landscape viewed in perspective projection.

In an embodiment of the present disclosure, the user may: (a) view the knowledge landscape on the at least one display device 230 as it is rendered by the CPU 212, the GPU 213, and in the browser 222 of the at least one client computers 210; and (b) navigate, explore, and interact with the knowledge landscape using the at least one input devices 240 and/or the peripheral devices 250 of the at least one client computers 210 in order to gain or convey knowledge or skills or to be evaluated for gained knowledge or skills.

In an embodiment of the present disclosure, the study item(s) may include a set of concepts (or topics) from at least one subject domain. Each of the concepts may have a text corpus associated with it. The similarity or distance between each pair of concepts may be computed by executing prescribed computerized instructions on the CPU 272 to analyze and compare the text corpora associated with them, using natural language processing techniques such as, e.g., multidimensional scaling or nonlinear mapping, and the relationships between study items inferred from user-item interaction data or inputted by users.

Alternatively, a virtual high-dimensional semantic space may be defined based on the vocabulary of the text corpora and/or the hyperlink structure of included documents on the World Wide Web, and the distance between concepts computed as, e.g., the Euclidean distance in it. The semantic space may then be reduced to one, two, or three spatial dimensions for display and navigation by executing prescribed computerized instructions on the CPU 272 for, e.g., dimensional reduction techniques that maximally maintain the distance information. The result including a set of calculated coordinates of the concepts in a finite space of one, two, or three dimensions may be stored in the at least one database 290. The coordinates, or points, may be extended to areas such as polygons via a tessellation such as, e.g., Voronoi tiling. In this case, the coordinates of the vertices of each polygon may also be stored in the at least one database 290.

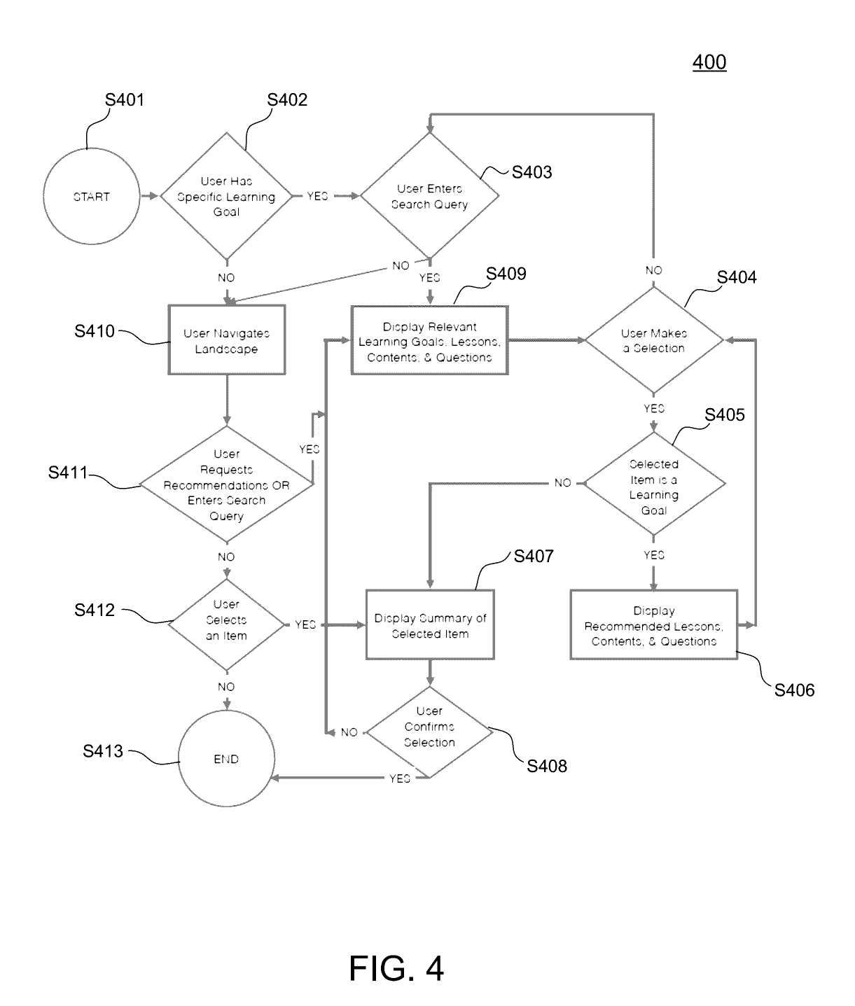

To achieve a desired outcome, the system 200 may monitor how learners may progress from one item to the next (e.g., learning session) as they interact with study items on the knowledge landscape as shown in, e.g., FIG. 4. The learning session may be analyzed to extract patterns and measure the efficacy of items (or sequences of items) in achieving associated learning goals, by performing statistical analysis of user-item interactions. The learning session may be further analyzed by including: (1) user inputs (such as view counts, vote counts, ratio of the view counts to the vote counts, user ratings, and the like), (2) concept dependency graphs describing, e.g., pre-requisite relations between concepts, created by domain experts and/or selected users, and (3) lessons, or sequences of study items put together by human users or computerized instructions based on results of statistical analysis.

The system 200 may show a dashboard-type summary of each user's learning profile (i.e., user profile), including, for example, a list of study items or lessons recently studied, mastered concepts or skills, completed questions or lessons, items or lessons created or registered by the user with view statistics and ratings, and at least one user-specific score quantifying the level of mastery exhibited and/or contributions made, for example, to the construction of the knowledge landscape.

The disclosed system 200 may be used both as an efficient content discovery tool for learning and as a recommendation engine for personalized contents and lessons. Due to its collaborative nature, the system may provide the following additional benefits to its users: (1) a community-edited overview of a subject area or a concept at a plurality of mastery levels; (2) personalized recommendation for multiple paths to achieve a learning goal based on algorithmic deduction of learner's competency profile computed using her learning history, comparison with other similar learners, and item profiles; (3) directions (e.g., signposts) and tips (e.g., warnings on pitfalls), insights, and advices from past learners who studied the same items or lessons; and (4) distributions of aggregated past responses to assessment questions, filtered by, e.g., grade level, geographical area, and time range. For example, a math teacher may wish to view a list of lesson paths associated with, e.g., a Common Core Standard, and read corresponding review(s) before selecting the lesson path at accurate grade level that is appropriate for her classroom lesson. Another example may be a student in remedial session trying to achieve a particular set of Performance Expectations that are part of the Next Generation Science Standards. The user may first take a quiz for quick evaluation and follow lessons recommended by the system, where each trail may include tips and insights provided by past learners.

In an aspect of the present disclosure, the system may follow client-server architecture. The client-server architecture may include a server computer and a plurality of client computers (as shown in e.g., FIGS. 1 and 2). The server and client may communicate through a network interface by any known connection protocol, for example, HyperText Transfer Protocol (HTTP). In addition to having a CPU, a memory, and a storage device, the server may save access to database, which may store data, such as, for example, user-item interaction data, user profiles, item profiles, item-item relations, lesson profiles, map/landscape data, and the like. A client computer may further include a CPU, a GPU, a memory, and a storage device, as well as a display device (e.g., computer monitors, display screens, virtual reality headsets), an input device (e.g., keyboards, mouses, track-pads, touch screens, microphones, and the like), and a peripheral device. The peripheral device may include, e.g., touchscreen, pen tablet, joystick, scanner, digital camera, video camera, microphone, and the like.

The server may send knowledge landscape data and user profile to a learner's client computer. Display device on client computer, through a browser in some embodiments, may then display the knowledge landscape to learner. The learner may use input devices to interact with knowledge landscape in manners similar to the examples described in TYPICAL USES OF INVENTION below. The learner may input (e.g., keyboard inputs, mouse clicks, trackpads, touch screens, voice commands, and the like) from an input device on client computer. The input may then be sent via network to server computer as requests (for, e.g., landscape data, lessons, contents, metadata such as average user ratings, recommendations, and the like) or as data to be processed and/or stored in database (for example, mastering a concept triggers an update in user profile in the database).

### TYPICAL USES OF INVENTION

### Case 1

### Learning Session

An example of a computer-based learning session that makes use of a collaborative knowledge landscape constructed according to the principles of the disclosure is illustrated as process 300 in FIG. 3. The process may include a user (or learner) logging onto a computer to start the process (S301), displaying a visual landscape (knowledge landscape) (S302), and navigating the visual landscape (S303), which may further include browsing items and/or lesson plans as further described in, e.g., FIG. 4. If it is determined that the user has selected an item or a lesson plan (S304), the user's profile may be automatically updated to reflect, e.g., the user's interest in, and interaction with, the item or the lesson plan (S305). If the user does not choose an item or a lesson plan, the learning session may revert back to visual landscape (S302).

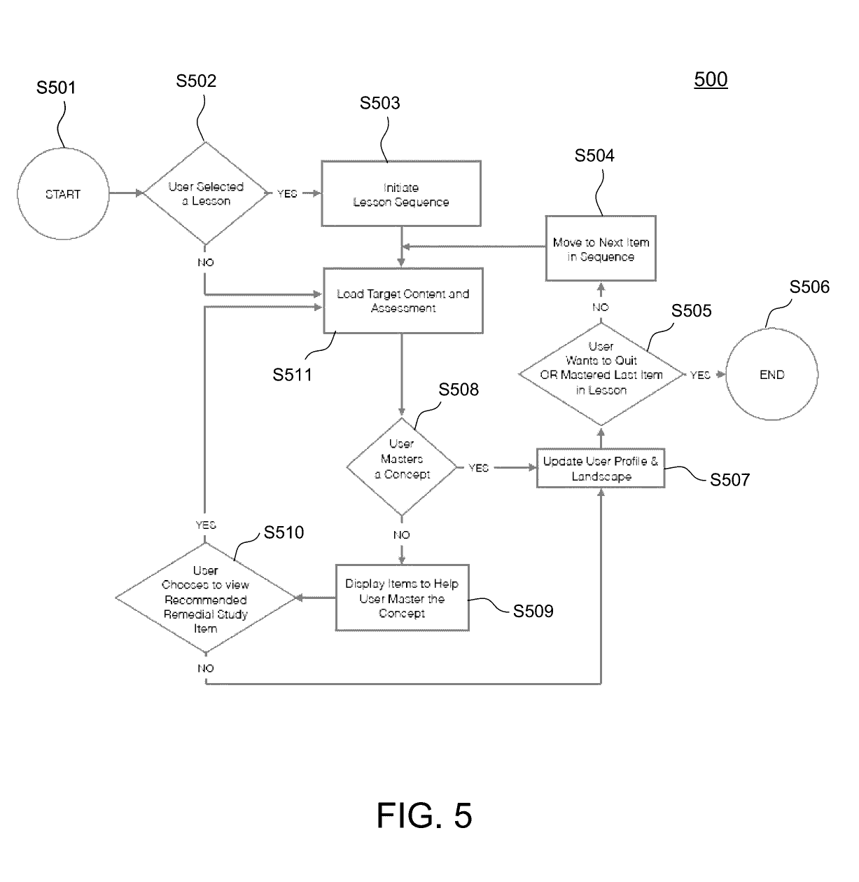

After the user profile is updated, the learning session (or system) may load the selected item or the lesson plan to the visual landscape (S306). At this point, the user may interact with the selected item or the lesson plan (S307) (as shown in, e.g., FIG. 5), which may continuously update the profiles of the user and the item or the lesson plan that the user interacts with (S308). For example, if the user responds to a question as part of a lesson plan, the learning session may automatically update the user profile and the item profile to capture the user-item interaction. The user-item interaction may include the user identification, the item identification, the user's response to the question, concept(s) or skill(s) related to the item or the lesson plan, whether or not the user's response to the question was correct, and the like. The questions and answers to the corresponding question may be stored in a database of the system. In an embodiment of the present disclosure, after a series of responses to a plurality of questions, the user's quantifiable proficiency or mastery level of an associated concept or skill may be updated and stored in the database. If the user chooses to continue learning, the learning session may display the visual landscape to begin the process again (S302). In some embodiments, the system may make personalized recommendations at this point for the next study items and/or lesson plans. If the user chooses to stop learning, then the learning session may end (S310).

FIG. 4 shows an example of a process 400 for an approach to navigating and selecting of study item or lesson. The process includes determining if a user has a specific learning goal (S402). This determination may be made in any suitable manner, such as, for example, prompting the user to click a preference button or a search box. If it is determined that the user has a specific learning goal, the process may receive a search query entered by the user related to the goal (S403), and may determine and display relevant study items and lessons (S409).

Alternatively (or additionally), the user may navigate the landscape guided by study items and lessons displayed on it and her prior knowledge of the domain (S410). The user may select to view recommendations for her lesson or enter a search query (S411). This determination may also be made in any suitable manner, such as, for example, prompting the user to click a preference button or a particular area of the landscape or to enter a query in a search box. If the user either wishes to view recommendations for her lesson or entered a search query, the process may determine and display relevant study items and lessons (S409).

The user may choose to not view recommendations, in which case the user may select another (or same) study item (or lesson) (S412). Then, if the user chooses to select the study item, the process may display a summary of the selected item (S407). The process may then prompt the user to confirm the selection (S408). If the user selects yes, it will end the process (S413). If the user selects no, the process will revert back to displaying relevant study items and lessons, and may re-determine and redisplay a list of relevant study items and lessons (S409).

After the user makes a selection from the recommended list (S404), the process will determine if it is a learning goal (S405). If it is determined to be a learning goal, the process will update the displayed list to show only lessons, contents, questions, and the like that are associated with the selected learning goal (S406).

FIG. 7 shows an example of a knowledge landscape 700 that is constructed in accordance with the present disclosure. Referring to FIGS. 1-2, and 7 concurrently, if a user inputs a question (e.g., is there life on Mars?), the system may generate and display a knowledge landscape 700. The user may navigate the knowledge landscape 700 by progressively zooming and panning in on and selecting (or clicking), e.g., an area of the knowledge landscape that contains the topic of interest, Mars 720, using, e.g., the zoom slider 780 and/or input devices such as keyboard and mouse. The zooming sequence may be, for example, Astronomy to Solar System to Solar System Planets to Mars. Once the knowledge landscape is sufficiently zoomed in, a calculated (or predetermined) number of study items may be shown as thumbnail images or clusters of thumbnails 730A-C on their respective coordinates on the knowledge landscape 700. The selection of displayed items may be determined by the recommendation engine 284 based on, for example, the user's interests, learning history, preferred learning mode(s), past user-item interaction data, and/or the user's competency profile associated with the study items and concepts. The thumbnail images 730A-C may include small number(s) to indicate count of recommended study items in each cluster of items. Other concepts or contents located adjacent the topic of interest 720 may also be displayed on the landscape 700. The interface 700 may include at least one score 750 that measures the user's proficiency or mastery level of a specific subject domain or a plurality of domains.

If the user clicks an area of the knowledge landscape that contains a study item, such as, for example, a topic of interest 720 in this illustrative example, the boundary of the area 740 (e.g., a polygon) and a sidebar 710 may be additionally displayed on the knowledge landscape 700. The sidebar 710 may include following information about the item (or lesson plan) that has been selected by the user: a type (e.g., concept) and a title of the study item (e.g., Mars), a ‘Like’ button 711, a selected statistics 712 such as view count, like count, difficulty or grade level of the item, a representative image or video 713, a brief summary 714, trails associated with the item 715, and a question(s) associated with the item 716. In addition, as shown in 750, other study items 770 associated with the selected item or recommended by the system may also be displayed in, e.g., carousel slider format.

The user may then type ‘life’ in the search box 760 and click on ‘Search in Displayed Area’. (Alternatively, the user could have initially typed ‘life on Mars’ as a search query and/or selected a learning goal closest to the user.) The study items and lessons only about ‘life’ and ‘Mars’ may be displayed, again computed by the recommendation engine 284. In an embodiment of the disclosure, a search query may be matched to tags that have been inputted by users or automatically generated by the system for each item or lesson. The user may click one of the recommended items to view more details in sidebar 710.

In some embodiments of the present disclosure, a number of lessons or learning paths (e.g., less than five or more than five) may be selected by the recommendation engine 284 based on the user's profile and proficiency in the related subject domain, concept(s) and/or skill(s), and present to the user on the knowledge landscape 700. The recommended study item or lesson may include a topic of, e.g., possibility of life on other planets, in particular, Mars.

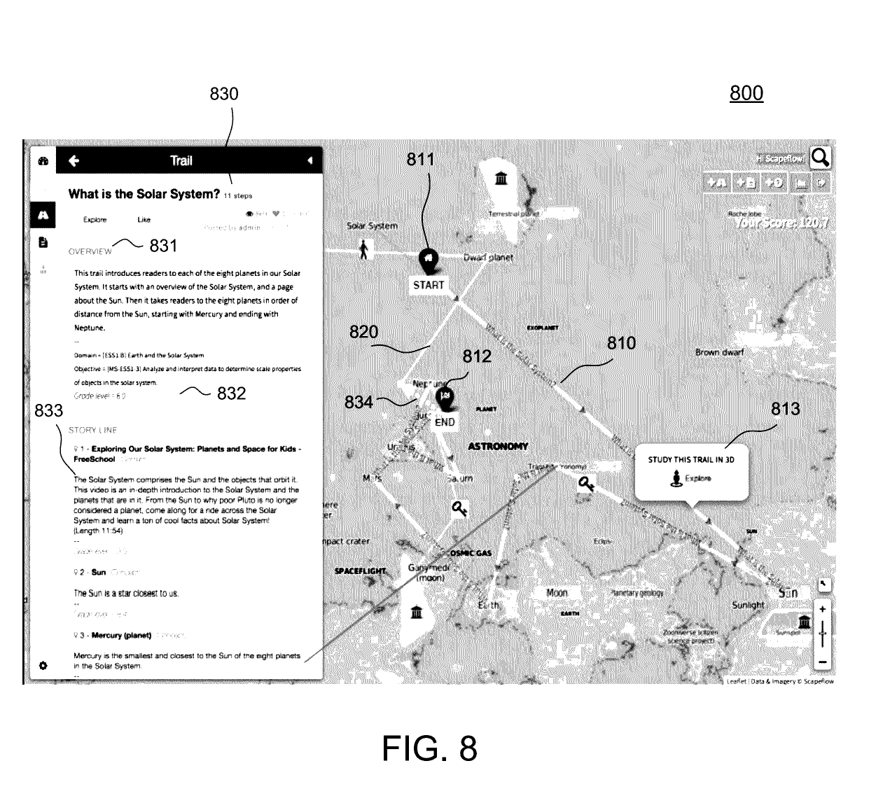

FIG. 8 shows an example of the knowledge landscape 800 that is constructed according to the principles of the disclosure. The knowledge landscape 800 may be displayed as a two-dimensional knowledge landscape that includes trajectories 810 and 820, each representing a particular sequence of study items for a lesson that may be displayed visually as trails on the knowledge landscape 800. In an embodiment of the present disclosure, a thickness or color of the trails may indicate their certain characteristics such as view count, vote count, average rating, efficacy measurement, and the like. The trails may display to the user overviews of the study item or the lesson plan, summaries of the study items, and reviews of the lessons, e.g., inputted by other users. If the user profile indicates that the user has mastered one or more of the concepts on the lesson, the corresponding items may be skipped during the lesson.

After the user selects one of the lessons, the selected lesson path 810 may be highlighted and starting point 811 and end point 812 of the lesson may be indicated by markers or icons. In an embodiment of the present disclosure, a sidebar 830 or a modal window may be displayed to the user. The sidebar 830 may include a title of the lesson, the number of items in the lesson sequence, selected statistics about the lesson such as view count, like count, difficulty or grade level, a lesson overview 831, subject domain, learning objective, and intended grade level 832. In some embodiments, the learning objectives, performance expectations, grade level, and the like may refer to national or local (state) standards such as, for example, the Common Core State Standards or the Next Generation Science Standards. Sidebar 830 may further include summaries 833 of study items that comprise individual steps of the lesson plan. Properties of each of the items such as the title, item type, length, grade level may also be displayed. Information provided about the lesson should be sufficiently thorough and detailed enough for the user to decide whether to study the items.

Additionally, a digital button (or a box) 813 may be displayed on the lesson path 810 or in sidebar 830 that a user may click or check to initiate the lesson sequence, which in some embodiments may occur in a three-dimensional knowledge landscape. The knowledge landscape 800 may include a dotted arrow 834 which may indicate that the lesson 810 is a pre-requisite for the lesson 820.

In an embodiment, visual attribute(s) (e.g., displayed icons, labels, geometric elements corresponding to study items or lessons, and the like) may be displayed or hidden when the zoom level of a knowledge landscape changes. For example, less popular trails and/or insignificant concepts may be displayed only at high zoom levels. This may be necessary to reveal clearly the structure of and the relationships among study items and lessons at each level.

In another embodiment, the user may register an alternate or a modified item for a specific step of an existing lesson plan.

FIG. 5 shows an example of a diagram of a process 500 for computer-based learning, in which a user interacts with study items or lessons in accordance with the principles of the disclosure. As shown, after the process 500 begins by, e.g., the user logging onto the system, and the like (S501). Then the user may have selected a lesson plan or a study item (S502). If the user has selected a lesson, the process 500 may initiate the lesson sequence (S503), and proceed to load and display the first target content or question (S511). If the user has selected a study item instead, the study item may be loaded and displayed to the user (S511).

In the case of a lesson, the user may proceed from one item to the next one in a sequence when the user is finished with the former item. In some embodiments, this sequence of steps may be visualized as movements in a two or three-dimensional knowledge landscape (shown in, e.g., FIGS. 7-10). In an embodiment of the present disclosure, the user may be finished with an item after, for example, reading content of a webpage, watching a video clip, or responding correctly to an assessment question or a series of questions. Here, these contents may be displayed at their unique coordinates and visualized as part of the knowledge landscape. In another embodiment of the present disclosure, the process 500 may include a preset criteria for mastery of a concept or a skill (e.g., a certain number or percentage of correct responses to a quiz), and the process 500 may be considered complete only if the criteria are met (S508). In the latter case, the learning sequence may continue until the user is evaluated to have mastered all (or part of) concepts or skills required by the selected lesson and/or achieved the user's learning goal.

After completing each item in the lesson, the user profile and user-item interaction data are updated to reflect the user's completion of the item (S507). In some embodiments, this update may occur even if the user fails to complete the item. If the user fails to complete each (or all) item in the lesson, the process 500 may display a remedial study item(s) to the user (S509). In an embodiment of the present disclosure, the remedial item may be similar in content but less difficult than the original item or may contain prerequisite concepts or skills required to master the original item. The process 500 may determine if the user has chosen to view a recommended remedial study item by, e.g., prompting the user to check a preference box or click a button (S510). If the user chooses to view the recommended study item, the process may load and display the remedial study item (S511). If the user chooses to not view the recommended study item, the process may record the user's failure to master the concept or skill (S507). At this point, the user may choose to quit this process or the item just displayed may be the only item or the last item in the lesson. In both cases, the process may end at S506. If not, the process may move to the next item in the lesson (S504), load and display it to the user (S511), which is repeated until it is determined that at least one answer to the two questions at S505 is positive.

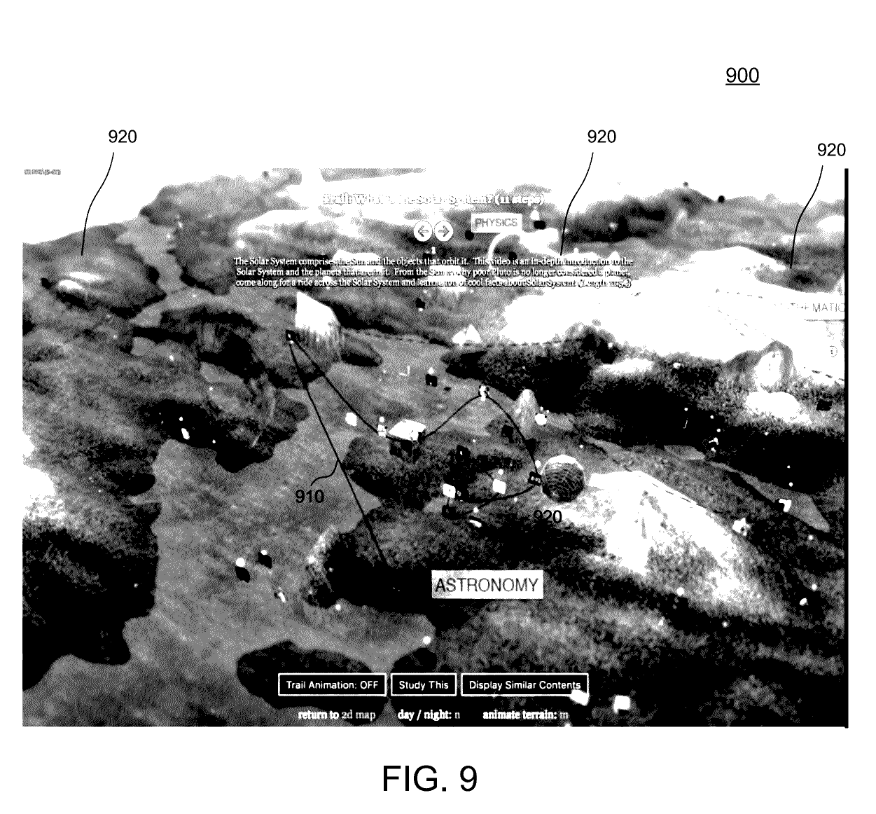

FIG. 9 shows an example of an elevated view of an example of a knowledge landscape 900 in the form of a three-dimensional landscape constructed according to the principles of the disclosure. The knowledge landscape may include a lesson trail 910 that may be displayed as a sequence of line segments, arcs, arrows, trodden paths, or the like. The lesson trail 910 may pass through all study items included in the lesson to give a preview of the subject domains 920 and/or concepts encompassed by the trail. For example, three subject domains (physics, mathematics, and astronomy) are visible in interface 900, and the selected trail lies in the domain of astronomy.

In an embodiment, the knowledge landscape 900 may simulate the visual appearance of natural or artificial environments as a virtual terrain. For example, a knowledge landscape may include a forest, grass field, desert, lake, river, ocean, mountain, icy land, metropolitan city, and the like.

In some embodiments, each study item in the lesson may be displayed on the knowledge landscape 900 as a particular object type. For example, it may be visualized as a billboard sign or a building, which shows a representative image of the item on the outside. Their visual attributes such as, for example, size, color, and shape, may indicate their characteristics, which in turn may be part of the profile of the study item or the lesson plan, and may include a significance measure or item type. Referring to FIGS. 2 and 9 concurrently, the user may use the input devices 240, such as, for example, keyboard (arrow keys), mouse, game console, and the like, in order to move around the knowledge landscape 900, and control the view displayed on their display device 230. For example, a user may see a study item that interests him and click it to automatically zoom onto it.

In an embodiment of the disclosure, road signs or signposts may be displayed on the knowledge landscape 900 to guide learners. For example, signposts may be displayed at or near crossroads, where more than one lesson plans meet and diverge in different directions.

In another embodiment, targeted advertisements of educational products or services may be displaced on the knowledge landscape 900. For example, targeted advertisements may be placed near those study items or lessons that have close conceptual relationships with them. Alternatively (or additionally), they may be shown only to users in a particular grade level or a measured proficiency or mastery level of an associated concept or skill.

In yet another embodiment, the knowledge landscape 900 may include a group of study items and lessons for corporate training. For example, it may include private lessons for employees of a company that are inaccessible from the outside world.

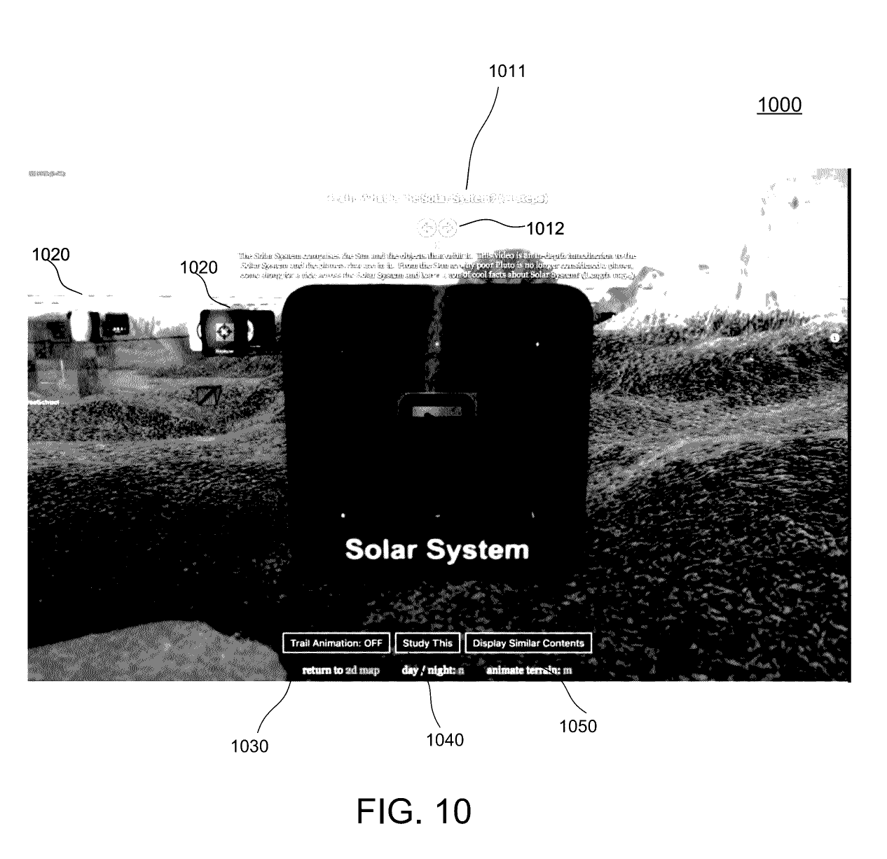

FIG. 10 shows an example of a knowledge landscape 1000 for exploring a three-dimensional knowledge landscape, in a view that zooms in on a particular study item. In this illustrative example, a main object 1010 is displayed as a billboard sign, but various object types including buildings, castles, lecture halls, historical landmarks, two or three-dimensional geometric shapes, crate boxes, trees, and the like may work as well. Other information about the lesson displayed on interface 1000 may include a lesson title 1011, a step number and arrows 1012 to move to a previous or next step, and a summary of the currently displayed study item 1013.

In an embodiment of the present disclosure, each subject domain, concept or topic may be visualized on the knowledge landscape 1000 as a building that contains a plurality of contents, e.g., reminiscent of museums or art galleries. For example, users may find in each building a group of contents and/or assessment questions associated with a subject domain, concept or topic. In another embodiment of the present disclosure, the group of contents and/or questions may be recommended by the system personally for each user based on characteristics of the user and of the items, as included in their profiles. In an embodiment, different floor levels of a building may represent difficulty measures or grade levels of study items or lessons.

In an embodiment of the present disclosure, the knowledge landscape 1000 may include button(s) to help the user move around the landscape and/or view selected or other study items. For example, clicking a ‘Trail Animation’ button 1030 may begin an animation that follows the trajectory of a selected lesson trail, showing each of the included items in sequence; a ‘Study this’ button 1040 may open, e.g., another webpage or a video displayed in a frame for the user to view; and a ‘Display Similar Contents’ button 1050 may show a group of related study items that is arranged as, e.g., cards on a two-dimensional plane or in a regular three-dimensional configuration such as a rectangular grid. In the last case, users may click one of the items, which may then be displayed on, e.g., the same main object 1010.

While navigating a knowledge landscape, a user may find additional item(s) 1020 that are not part of the selected lesson trail (but may be located nearby), and decide to study them by selecting (e.g., clicking) on the additional item 1020. Since the coordinates of study items are uniquely determined based on the item profiles and their conceptual relationship, and because high quality study items are more likely to be recommended based on statistical analysis of past user-item interaction data, an interface constructed according to the principles of the disclosure may increase the chance for users to discover new high quality contents closely related to their interests or learning goals.

### Case 2

### Creating a New Lesson

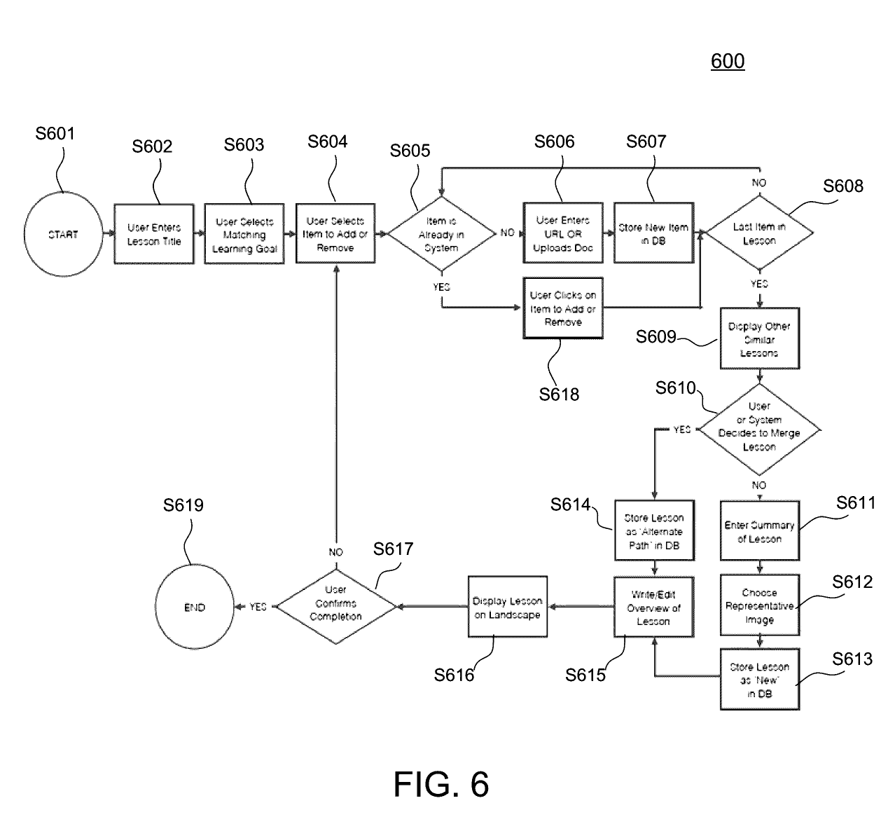

In some embodiments, a new lesson plan may be created, registered, and stored in the system as illustrated in process 600 of FIG. 6. Referring to FIGS. 2 and 6-10 concurrently, a user may, for example, click a ‘Create New Lesson’ icon on the display device, and proceed to enter a title for the lesson (S602). The user may then select a learning goal that matches the user's intention or question (for example, “What is a black hole?”) from a list of related learning goals stored in the system (S603).

Then the user may select to add each item, one by one, into the lesson (S604). If the user knows that a particular item is already in the system (S605), he may locate it on a knowledge landscape, click on it and select, e.g., an ‘Add to Lesson’ button (S618). The process may prompt the user to select an ‘item type’ (e.g., webpage, video, quiz, concept), and once the user makes a selection, display a list returned by the system so that the user may select one of the recommended items. Alternatively, the user may register a new content by entering the URL of the content (S606). If the item is not already in the system, the user may enter URL or upload local file (for example, text, PDF document, PowerPoint/Keynote slides, image, audio, video, or the like), which may then be stored in the database as a new item (S607). In some embodiments, the new item's coordinate may be computed by the landscape construction engine 285 on a server memory 280. The item's visible coordinate may be shown to the user on a knowledge landscape. This process may repeat itself until the user finishes adding the last item into the lesson (S608).

At this point, the recommendation engine 284 on the server 270 may identify a set of existing lessons, if any, sufficiently similar to the one just created (S609) in terms of, for example, the concepts traversed and difficulty levels of the included items. The user, guided by system recommendation, may choose to merge his lesson (S610), which may then be stored to the database as an ‘alternate path’ to an existing lesson (S614). If the user decides to not merge the lesson, the user may enter a summary (S611), select a representative image for the new lesson (S612), and store the representative image in the database (S613). At this point, the user may write a new overview or edit an existing one for the lesson (S615). The resulting lesson may be displayed as a visual trajectory on a knowledge landscape for the user to review (S616). The process may prompt the user to choose whether he wants to modify the lesson (S617), (e.g., add or remove items). If the user chooses yes, the system will loop back so that the user may select item to add or remove (S604). If the user chooses no, the process is complete (S619).

In an embodiment, a plurality of chapters of a book or a plurality of clips of a video may be registered and displayed on the knowledge landscape as steps of a lesson.

### Case 3

### Knowledge Landscape

A knowledge landscape (as shown in, e.g., FIGS. 7-10) may include a computer graphical representation of virtual terrains, on which study items and lesson paths (from, e.g., the World Wide Web or textbooks) may be spatially organized in a manner that reflects their conceptual similarities and relationships. The knowledge landscape may further provide a visual display interface for navigation and exploration (e.g., zooming, panning operations, and the like) of contents as well as for actual learning, leading to an engaging and seamless user experience. The study items and lessons may be crowdsourced, and learners may add new items or lessons to knowledge landscape and also provide feedback (e.g., ratings and re-views) on those that they have used. In one embodiment of the present disclosure, the system may, based on learners' collective inputs and user-item interactions during learning, continually or intermittently update the knowledge landscape according to prescribed computerized instructions and identify preferred learning paths to achieve given learning goals such that the overall experience and efficacy may be improved. The resulting system may be used as a content discovery tool, an intelligent content curation platform, and a recommendation engine for adaptive, personalized learning.

The knowledge landscape may include the following purposes and features: (a) provide a basic environment for learners to navigate, explore, and interact with study items; (b) contain a spatial configuration of study items determined algorithmically based on conceptual and ontological relationships and user interaction patterns, and as a result, provides unique coordinates for all individual items and a group of intricate connections and relationships among them; (c) form a hierarchical spatial structure consisted of subject domains, sub-domains, concepts, contents, and the like based on an interconnected nature of study item(s) (or lesson plans); (d) store study items, aggregated user interaction data, and relationships among the items and users; and (e) construct collaboratively, and change dynamically over time, in response to user inputs, via forms (e.g., adding study items or lessons, user ratings) and through interaction with the system, from a plurality of users.

In an embodiment of the present disclosure, the knowledge landscape may include a set of geometric areas such as polygons, each of which represents a subject, a concept, or a topic, with a group of lesson path(s) (i.e., trails), represented as a plurality of line segments or arrows, overlaid on top of the lesson paths. Each geometric area may include a plurality of study items (e.g., contents, assessment questions), which may be represented, for example, as points or sets of points.

The construction and update of the knowledge landscape may occur based on a set of algorithms (e.g., computerized instructions) in a way that, over time, reinforces those items and lessons with high efficacy and user ratings, and weakens those with low efficacy and ratings. When a new item is entered into the system, the new item is given a specific coordinate on said landscape consistent with the configuration of existing items, whose coordinates may be also subject to change due to the new item. In one embodiment of the present disclosure, after a certain period of time with inputs that are accumulated from different users, the collected data may uncover underlying flow patterns on a variety of scales on the knowledge landscape, which capture preferred learning paths on the conceptual level.

In further embodiments of the present disclosure, the knowledge landscape may include at least one coordinate representing conceived or measured difficulty of study items. The knowledge landscape may also use various visual attributes (e.g., size, width, color, shape, icon, surface texture, brightness, and the like) to represent different quality attributes of concepts, contents, assessment questions, or lessons (e.g., view counts, average user ratings, estimated efficacy of items or lessons, and the like). Furthermore, study items and lessons may be connected via lines, arrows, and the like, in order to indicate their rich ontological relationships graphically. For example, green arrows may be drawn from a set of contents to a concept to indicate that the contents are about the concept. Similarly, an orange arrow may be drawn between two lesson paths to indicate a prerequisite relationship.

The knowledge landscape may further include a two-dimensional landscape, a three-dimensional landscape, a four-dimensional landscape (including one dimension of time), or a plurality of such landscapes, having a single global coordinate system, on which more similar items may be placed gradually closer to each other. A structure of the landscape may change dynamically over time in response to user inputs and interactions.

The knowledge landscape may include a group of a plurality of the items, connected by a plurality of sequences of directed weighted edges in the forms of lines, arrows, and the like, thereby forming linear sequences, loops, trees, or graphs, called “lessons” in some embodiments, which may contain certain degrees of temporal or logical precedence of various importance or prominence and may include basic narrative units.

The basic narrative units may include a sequence of study items or lessons that is inputted by a user or pulled from World Wide Web in a predetermined order, e.g., chronological, logical, and the like.

The logical precedences (e.g., prerequisite or predetermined relationship between concepts and skills) may also be predetremind by experts in the lesson or the study item. The logical precedences may also be predetremind by experts in subject domain. For example, the Common Core State Standards or the Next Generation Science Standards may include the prerequisite relationship between concepts and/or skills associated with lessons or study items. With additional user interaction and input, the system may update the logical precedence for the corresponding lesson or the study item.

The lessons may be associated with at least one learning goal, a set of characteristics of said items and said lessons on said landscape that are determined, organized, visualized, and updated in a collaborative, self-adjusting manner based on their conceptual and ontological relationships, aggregated user-item interactions, efficacy measurements, and user inputs and feedback.

The user may use the graphical interface to interact with said items and said lessons represented on said landscape, for the purpose of browsing, navigating, exploring, selecting, accessing, studying, teaching, testing, adding, editing, expanding, reviewing, rating, etc. information item(s) or lesson(s) to gain or convey knowledge or skills or to be evaluated for gained knowledge or skills.

In an embodiment of the present disclosure, the landscape may be visualized as a scenery (landscape, seascape, cityscape, underground, outer space, or the like), or a combination of sceneries. The landscape may be displayed to user as tiled maps or in perspective projection, including tilted-satellite (or similar) projection and/or in fly-through mode.

In another embodiment, the user may use virtual reality or augmented reality devices, such as, for example, wearable headsets, and the like, to view and interact with said landscape for immersive learning experience.

The lessons may represent lesson plans for teaching or learning. The lessons may contain as their sub-sequence other existing lessons.

The lessons may be inputted by users of the system or by original content creators, or automatically formed and entered into the system based on analyses of existing items and lessons and a set of computerized instructions.

In some embodiments, at least one of the spatial dimensions may represent conceived or measured difficulty of said items. The items or said lessons may further be organized into multiple tiers based on their conceived or measured difficulty levels.

The visual features and structures of the items and the lessons may be determined and organized based on conceptual and ontological relationships between contents and/or analyses of aggregated usage patterns and user data (e.g., user ratings).

The visual attribute(s) of the items or the lessons may include, for example, lines, polygons, coordinates, paths, elevations, depths, environments, surface textures, shapes, icons, sizes, widths, distances, colors, brightness, and the like. For example, in one embodiment of the present disclosure, the system may allow users to construct new lesson paths by connecting a plurality of study items, and those paths may be visualized on the landscape with different widths and colors representing their relative significance or efficacy measured over time.

Rich ontological relationships between items, between lessons, and between items and lessons, including subclass, superclass, similarity, and hierarchy relations, may be visualized graphically on said knowledge landscape explicitly, using, e.g., lines, arrows, Venn diagrams, trees, graphs, and the like. For example, lines between study items may indicate similarity relations, and arrows between lessons may indicate prerequisite relations.

The aggregated user inputs may affect, among other things, a unique coordinate and a unique trajectory for each item and each lesson, respectively, on said landscape and their relative importance or prominence, at a given time.

The learning activities, competency levels, and outcomes of each individual user may be summarized on said landscape or on a separate page or frame in a graphical, animated, audio, video, textual, and/or numerical form, and presented to the user. For example, area-filling polygons with various colors and opacities may indicate a user's competency level in each of the regions. The colors may change over time as the user proceeds with learning.

The contributions of each user to construction of said landscape, e.g., creation or addition of study items or lessons, may be summarized in a graphical, animated, audio, video, textual, and/or numerical form, and presented to the user.

In an embodiment of the present disclosure, the disclosed method, system, and computer program may include an online virtual world, such as, for example, Second Life®, SimCity®, MineCraft®, and the like, where contents and visual elements (for landscape) are added and edited manually by a community of a plurality of users, in a style similar to e.g., Wikipedia, instead of knowledge landscape shaped algorithmically by a set of computerized instructions on a dedicated learning system.

In an alternative, the details of how the knowledge landscape is constructed may be changed in a systematic manner by e.g., a community of users who edit contents and build, change, relocate, and remove buildings, and other visual elements that represent study items and lesson paths or their relationships.

Furthermore, the knowledge landscape may be constructed by combining human knowledge with machine learning algorithms. For example, the system may be configured to allow only domain experts may contribute to creating and/or updating study items, lessons, or knowledge landscape.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A computer-implemented system for collaborative learning, comprising:
a computer comprising a display, a graphics processing unit, and a microprocessor, the computer programmed to receive at least one item and transmit the at least one item,
a server comprising a central processing unit and a memory, the server configured to receive the at least one item from the computer, the memory having the at least one item stored therein, and the central processing unit programmed to:
determine a group of the at least one item that is connected by a plurality of weighted edges;
determine at least one set of characteristics based on the at least one item and the group of the at least one item;
determine at least one measured relationship between each characteristic in the at least one set of characteristics; and
generate a visual landscape or a plurality of visual landscapes, that is determined, organized, visualized, and updated based on the at least one measured relationship,
send the visual landscape or the plurality of visual landscapes to the computer;
wherein the graphics processing unit is configured to display the visual landscape on the display, and
wherein the computer is connected to the server via a communication link.

2. The system of claim 1, wherein the server comprises a graphics processing unit that is configured to execute at least part of the central processing unit's programming.

3. The system of claim 1, wherein the at least one item comprises at least one of concept, topic, content, document, question, learning goal, objective, and/or performance expectation.

4. The system of claim 1, wherein the weighted edges comprise any one or more of linear sequences, non-linear sequences, loops, trees, graphs, and/or combination thereof.

5. The system of claim 1, wherein the central processing unit is further programmed to create a mathematical model to calculate at least one measured relationship between characteristics.

6. The system of claim 1, wherein the characteristics comprise at least one of user-item interaction data, user profiles, item profiles, item-item relations, and lesson profiles.

7. The system of claim 1, wherein the group of the at least one item comprise at least one lesson plan that is arranged in a sequence or a directed graph that is based on a degree of temporal or logical precedence.

8. The system of claim 7, wherein the at least one item or the at least one lesson plan is organized into multiple tiers based on their measured difficulty level.

9. The system of claim 7, wherein the at least one item or the at least one lesson plan is inputted by a user.

10. The system of claim 9, wherein the input comprises at least one of graphical, textual, or numerical form.

11. The system of claim 7, wherein the at least one lesson plan is automatically formed based on analyses of the visual landscape and the group of the at least one item.

12. The system of claim 7, wherein a visual attribute of the at least one item or the at least one lesson plan in the visual display is determined and organized based on at least one conceptual relationship between any one or more of the at least one item, the group of the at least one item, the at least one lesson plan, and a user feedback.

13. The system of claim 7, wherein a visual attribute of the at least one item or the at least one lesson plan in the visual display is determined and organized based on the at least one set of characteristics of any one or more of the at least one item, the group of the at least one item, the at least one lesson plan, and a user feedback.

14. The system of claim 12, wherein the visual attribute comprises at least one of geometric or geographical property.

15. The system of claim 12, wherein the visual attribute comprises at least one of line, polygon, coordinate, path, area, volume, elevation, depth, environment, surface texture, shape, icon, size, width, distance, color, and/or brightness.

16. The system of claim 1, wherein the visual landscape comprises at least one of landscape, seascape, cityscape, underground, and/or outer space.

17. The system of claim 1, wherein the visual landscape is displayed to a user in a static or dynamic manner.

18. The system of claim 1, wherein the visual landscape is displayed in a two-dimensional or three-dimensional space.

19. The system according to claim 1, wherein the microprocessor is configured to display the visual landscape on the display.

20. The system of claim 1, further comprising a computer input apparatus that is configured to permit a user to navigate and zoom in and out of the visual landscape.

21. A non-transitory computer readable storage medium tangibly embodying a computer readable program code having computer readable instructions which, when implemented, cause a computer to carry out a plurality of method steps comprising:
receiving at least one item from a user on the computer, and
transmitting the at least one item to a central processing unit on a server,
wherein the central processing unit is configured to execute the steps comprising:
determining a group of the at least one item that is connected by a plurality of weighted edges;
determining at least one set of characteristics based on the at least one item and the group of the at least one item;
determining at least one measured relationship between each characteristic in the at least one set of characteristics; and
generating a visual landscape or a plurality of visual landscapes that is continuously determined, organized, visualized, and updated based on the at least one measured relationship.

22. The method according to claim 21, wherein the computer comprises a graphics processing unit that is configured to execute at least part of the central processing unit's programming.

23. A computer-implemented system for collaborative learning, comprising:
a computer comprising a display, a graphics processing unit, and a microprocessor, the computer programmed to receive at least one item and transmit the at least one item,
a server comprising a central processing unit and a memory, the server configured to receive the at least one item from the computer, the memory having the at least one item stored therein, and the central processing unit programmed to:
determine a group of the at least one item that is connected by a plurality of weighted edges;
determine at least one set of characteristics based on the at least one item and the group of the at least one item;
determine at least one measured relationship between each characteristic in the at least one set of characteristics; and
generate a visual landscape or a plurality of visual landscapes, that is determined, organized, visualized, and updated based on the at least one measured relationship,
send the visual landscape or the plurality of visual landscapes to the computer;
wherein the microprocessor is configured to display the visual landscape on the display, and
wherein the computer is connected to the server via a communication link.
